(19) United States
(12) Patent Application Publication
(10) Pub. No.: US 2016/0194239 A1
(43) Pub. Date: Jul. 7, 2016

(54) GLASS COMPOSITION AND STRENGTHENED GLASS SHEET

(71) Applicant: NIPPON SHEET GLASS COMPANY, LIMITED, Tokyo (JP)

(72) Inventor: Hiromitsu SETO, Hyogo (JP)

(21) Appl. No.: 14/917,205

(22) PCT Filed: Sep. 3, 2014
(86) PCT No.: PCT/JP2014/004535

§ 371 Date: Mar. 7, 2016

(30) Foreign Application Priority Data
Sep. 9, 2013 (JP) 2013-186692

(51) Int. Cl. C03C 3/095; C03B 27/012; C03C 3/087

(52) U.S. Cl. CPC C03C 3/095; C03C 3/087; C03B 27/012

(57) ABSTRACT

The present invention provides a MnO-free glass composition having a FeO ratio of 30% or less, excellent ultraviolet and near-infrared absorbing ability, and a high visible light transmittance. The present invention relates to a glass composition containing, in mass %: 71 to 78% SiO₂; 0 to 5% B₂O₃; 1 to 5% Al₂O₃; 1 to 3.5% MgO; 2 to 9.5% CaO; 0 to 1% SrO; 0 to 1% BaO; 0 to 3% Li₂O; 10 to 18% Na₂O; 0 to 3% K₂O; 0 to 1% TiO₂; 0 to 1% CeO₂; 0 to 0.5% SO₃; and 0.6 to 1.2% T-Fe₂O₃, which is total iron oxide in terms of Fe₂O₃. This glass composition is free of MnO, the total content of TiO₂ and CeO₂ is 0.05% or more, the total content of Li₂O, Na₂O, and K₂O is 12 to 18%, and the total content of MgO, CaO, SrO, and BaO is 10.5% or less.

### TECHNICAL FIELD

The present invention relates to a glass composition having a low ultraviolet transmittance, a low near-infrared transmittance, and a high visible light transmittance. More specifically, the present invention relates to a glass composition suitable for use in vehicles and buildings, in particular, in vehicle windows.

### BACKGROUND ART

Soda-lime glass is used in vehicle and building windows. In terms of energy saving, there is a demand for window glass having higher near-infrared absorbing ability. Near-infrared absorbing ability of soda-lime glass depends mainly on absorption by divalent iron oxide. Window glass is sometimes required to have ultraviolet absorbing ability in addition to near-infrared absorbing ability. Ultraviolet absorbing ability of soda-lime glass depends on absorption by trivalent iron oxide and absorption by ultraviolet absorbing components such as titanium oxide (TiO₂), which are added as needed. In a glass composition, iron is present in the form of divalent iron oxide (FeO) or trivalent iron oxide (Fe₂O₃). The ratio of divalent iron oxide to total iron oxide in soda-lime glass is referred to as a FeO ratio, and the FeO ratio as well as the content of total iron oxide are to be controlled. The FeO ratio used in this description is defined as a ratio of divalent iron oxide to total iron oxide in terms of trivalent iron oxide.

Window glass is also required to have a high visible light transmittance to maintain its original function. In particular, for certain types of window glass for vehicles, such as glass for windshields and front door windows of automobiles, a standard visible light transmittance to be achieved is determined and regulated by law in order to ensure visibility. The standard visible light transmittance is set at a level of about 70% or more, although it varies from country to country.

Patent Literature 1 (WO 2005/063643 A1) discloses a glass composition having excellent ultraviolet and near-infrared absorbing ability and a high visible light transmittance and thus being suitable for use as window glass for vehicles and others. Patent Literature 1 discloses examples of glass compositions containing a small amount of manganese oxide (MnO). MnO is a component for controlling the color tone and FeO ratio of glass.

### CITATION LIST

### Patent Literature

Patent Literature 1: WO 2005/063643 A1

### SUMMARY OF INVENTION

### Technical Problem

Addition of MnO is one of the factors increasing the cost of raw materials of a glass composition because, for example, it is difficult to stably obtain inexpensive raw materials of MnO. Therefore, it is desirable that the glass composition be free of MnO in terms of mass production. In order to achieve both near-infrared absorbing ability and ultraviolet absorbing ability, it is advantageous to add an ultraviolet absorbing component such as titanium oxide and, in addition, to set a high FeO ratio. However, if the glass raw materials are melted under highly reducing conditions to achieve a high FeO ratio, silica scum is likely to occur in the glass melt.

It is therefore an object of the present invention to provide a MnO-free glass composition having excellent ultraviolet and near-infrared absorbing ability and having a high visible light transmittance.

### Solution to Problem

The present invention provides a glass composition containing, in mass %; 71 to 78% SiO₂; 0 to 5% B₂O₃; 1 to 5% Al₂O₃; 1 to 3.5% MgO; 2 to 9.5% CaO; 0 to 1% SrO; 0 to 1% BaO; 0 to 3% Li₂O; 10 to 18% Na₂O; 0 to 3% K₂O; 0 to 1% TiO₂; 0 to 1% CeO₂; 0.05 to 0.5% SO₃; and 0.6 to 1.2% T-Fe₂O₃, which is total iron oxide in terms of Fe₂O₃. This glass composition is free of MnO, the total content of TiO₂ and CeO₂ is 0.05% or more, the total content of Li₂O, Na₂O, and K₂O is 12 to 18%, and the total content of MgO, CaO, SrO, and BaO is 10.5% or less.

### Advantageous Effects of Invention

According to the present invention, it is possible to provide a MnO-free glass composition having excellent ultraviolet and near-infrared absorbing ability and having a high visible light transmittance. The glass composition of the present invention has, for example, an ultraviolet transmittance of 18% or less, a visible light transmittance of 72% or more, and a light transmittance of 34% or less at a wavelength of 1500 nm in the near-infrared region.

### DESCRIPTION OF EMBODIMENTS

Embodiments of the present invention are described below, but the present invention is not intended to be limited to the embodiments so described. In the following description, the contents of the components are all expressed in mass %, and the content ratios are also expressed in terms of mass. YA, Tuv, and T1500 represent a visible light transmittance, an ultraviolet transmittance, and a light transmittance at a wavelength of 1500 nm, respectively. These transmittances are calculated assuming that the glass has a thickness of 3.5 mm. MgO, CaO, SrO, and BaO are collectively referred to as RO, and Li₂O, Na₂O, and K₂O are collectively referred to as R₂O. In the present description, the phrase “be substantially free of (a component)” is used to mean that the content of the component is less than 0.1 mass %, preferably less than 0.05 mass %, and particularly preferably less than 0.01 mass %.

[Components of Composition]

First, the components of the glass composition of the present invention are described.

(SiO₂)

SiO₂ is a major component of glass. The content of SiO₂ in a glass composition is at least about 65% only to impart durability to the glass composition. However, the content of SiO₂ is adjusted to about 71% or more to achieve both a high YA and a low T1500. As described later, in order to achieve both a higher YA and a lower T1500, the total content of SiO₂ and Al₂O₃ is preferably about 74% or more, and in order to achieve this total content, the content of SiO₂ is preferably 72% or more, and particularly preferably 72.5% or more. In order to achieve an even higher YA, the content of SiO₂ is preferably 73% or more, more preferably 74% or more, and it may be 75% or more in some cases. If the content of SiO₂ is too high, it is difficult to melt the glass material. Therefore, the content of SiO₂ is preferably 78% or less, particularly preferably 77.5% or less, and it may be 77% or less in some cases.

(B₂O₃)

B₂O₃ is not an essential component, but the glass composition may contain up to 5% B₂O₃ as a melting aid, for example. If the content of B₂O₃ is too high, a production problem may occur due to its volatility. The content of B₂O₃ is preferably less than 3%, and particularly preferably less than 2%. The glass composition may be substantially free of B₂O₃.

(Al₂O₃)

The content of Al₂O₃ is adjusted within a range of 1 to 5%. The content of Al₂O₃ in a glass composition having a low RO content is preferably 1.3% or more, and particularly preferably 1.5% or more to compensate for a decrease in the durability of the glass composition. However, if the content of Al₂O₃ is too high, it is likely to be difficult to melt the glass material. In addition, Al₂O₃ reduces the thermal expansion coefficient. Therefore, the content of Al₂O₃ is preferably 2.5% or less when the glass composition is thermally strengthened (thermally tempered).

In order to achieve both a higher YA and a lower T1500 in a well-balanced manner, the total content of SiO₂ and Al₂O₃ is preferably 73.9% or more. The glass composition having this preferable total content can achieve both a YA of 72.7% or more and a T1500 of 33% or less. More preferably, the total content of SiO₂ and Al₂O₃ is 74.3% or more. The glass composition having this more preferable total content can achieve both a YA of 73% or more and a T1500 of 33% or less.

(MgO)

The content of MgO is adjusted within a range of 1 to 3.5%. MgO is a component that contributes to an increase in the durability of the glass composition and that can be used to adjust the devitrification temperature and viscosity thereof. If the content of MgO is too high, the glass composition has a higher devitrification temperature and thus cannot be used for mass production by a float process. It is desirable to reduce the content of MgO to shift the absorption peak of FeO to longer wavelengths. Such shift of the absorption peak of FeO to longer wavelengths is an effective means for achieving both a higher YA and a lower T1500.

More specifically, the content of MgO is preferably 1 to 2.5%, and more preferably 1 to 2%, and it may be 1 to 1.8% in some cases. However, as described above, there is no need to minimize the content of MgO when the total content of SiO₂ and Al₂O₃ is increased to about 74% or more (specifically, 73.9% or more or even 74.3% or more). In this case, it is recommended to adjust the content of MgO, for example, to 2 to 3.5%, particularly to 2 to 3%, to maintain the durability.

(CaO)

The content of CaO is adjusted within a range of 2 to 9.5%. Like MgO, CaO is also a component that contributes to an increase in the durability of the glass composition and that can be used to adjust the devitrification temperature and viscosity thereof, although the effectiveness of CaO is different from that of MgO. The content of CaO is preferably 3 to 9%, and more preferably 4 to 9%. The content of CaO may be 7 to 9.5% in some cases. When the total content of SiO₂ and Al₂O₃ is increased to about 74% or more, the content of CaO is preferably 4 to 7%. It is desirable to reduce the content of CaO to shift the absorption peak of FeO to longer wavelengths. However, if the content of CaO is too low, the viscosity of the glass melt is too high, which may affect the refining of the glass melt.

(SrO and BaO)

SrO and BaO are not essential components, but the glass composition may contain up to 1% SrO and up to 1% BaO, preferably up to 0.5% SrO and up to 0.5% BaO, as components contributing, for example, to an increase in the durability of the glass composition. It is necessary to use relatively expensive raw materials for SrO and BaO compared to the materials for other components such as CaO. BaO requires careful handling. Therefore, the glass composition may be substantially free of SrO and BaO.

(RO)

The content of RO (i.e., the total content of MgO, CaO, SrO, and BaO) is 10.5% or less, preferably 10.3% or less. The lower limit of the RO content is not particularly limited. The lower limit of the RO content is usually 6% or more, for example, even 7% or more, particularly 8% or more, and the appropriate lower limit of the RO content is 8.5% or more in some cases. When the total content of SiO₂ and Al₂O₃ is adjusted to about 74% or more (specifically, 73.9% or more or even 74.3% or more), the content of RO may be less than 10%, particularly 9.5% or less, and the appropriate content of RO is, for example, 5 to 9.5%.

In order to achieve both a higher YA and a lower T1500 in a well-balanced manner, the content of MgO is preferably 1 to 2% and the content of CaO is preferably 7 to 9.5%. Preferably, the glass composition is substantially free of SrO and BaO. The glass composition having these preferable contents can achieve both a YA of 72.6% or more and a T1500 of 33% or less, particularly both a YA of 72.6% or more and a T1500 of 31.5% or less.

When the total content of SiO₂ and Al₂O₃ is adjusted to about 74% or more (specifically, 73.9% or more or even 74.3% or more), the glass composition may have a MgO content of 2 to 3.5% and a CaO is 4 to 7% and may be substantially free of SrO and BaO.

In view of the above-mentioned preferable contents, the ratio of the SiO₂ content to the RO content (SiO₂/RO) is preferably 7 or more. The SiO₂/RO ratio may be 8 or more or even 10 or more in some cases.

(Li₂O, Na₂O, and K₂O)

Li₂O, Na₂O, and K₂O are alkali metal oxides which help melt the glass material as melting accelerators. Li₂O is an optional component, and the glass composition may contain up to 3%, preferably up to 1% Li₂O. The glass composition may be substantially free of Li₂O. In terms of production cost, it is desirable to use Na₂O as one of the alkali metal oxides. The content of Na₂O is adjusted within a range of 10 to 18%. Preferably, the content of Na₂O is 12 to 16%. K₂O is an optional component, and the glass composition may contain up to 3%, preferably up to 1.5% K₂O. The content of K₂O may be, for example, 0.5 to 1.5%.

(R₂O)

The content of R₂O (i.e., the total content of Li₂O, Na₂O, and K₂O) is adjusted within a range of 12 to 18%. The content of R₂O is preferably in a range of 13 to 16%. If the content of R₂O is too high, the durability of the glass composition may decrease.

(TiO₂)

TiO₂ is one of the components responsible for ultraviolet absorption. TiO₂ has an ability to adjust the color tone of a high FeO ratio glass from a bluish color to a greenish color. The glass composition having a high TiO₂ content tends to take on a yellow tinge. There are other components responsible for ultraviolet absorption. Therefore, TiO₂ is considered as an optional component and the glass composition may contain up to 1% TiO₂. However, it is desirable to add a small amount of TiO₂ in some cases as a component having an ability to reduce the devitrification temperature. The content of TiO₂ is preferably 0.05% or more, more preferably 0.08% or more, and particularly preferably 0.1% or more.

(CeO₂)

CeO₂ is also one of the components responsible for ultraviolet absorption. However, addition of CeO₂ causes an increase in production cost. CeO₂ may cause a change in the optical properties of the glass composition, by affecting redox reaction of iron oxide in the glass composition after the glass composition is formed into a desired shape. There are other components responsible for ultraviolet absorption. Therefore, CeO₂ is considered as an optional component and the glass composition may contain up to 1% CeO₂. However, it is desirable to add a small amount of CeO₂ in some cases as the most effective component for reducing the Thy while maintaining a high YA. The content of CeO₂ is preferably 0.05% or more, more preferably 0.1% or more, and particularly preferably 0.3% or more.

In order to achieve a low Tuv, the total content of TiO₂ and CeO₂ is preferably 0.05% or more, more preferably 0.1% or more, and particularly preferably 0.3% or more, and it may be 0.5% or more in some cases. The content of TiO₂ and the content of CeO₂ are each preferably 0.05% or more to achieve an appropriate Thy while preventing the negative effects of high contents of TiO₂ and CeO₂. The upper limits of the TiO₂ content and the CeO₂ content are each preferably 1.5% or less, more preferably 1% or less, and they may be 0.9% or less in some cases.

(SO₃)

The glass composition may contain up to 0.5% SO₃ as an optional component for accelerating refining of glass. The content of SO₃ is preferably in a range of 0.05 to 0.5%. If the content of SO₃ is too high, SO₂ bubbles produced by decomposition of SO₃ may remain in the glass composition or SO₂ bubbles may be produced by reboiling. The content of SO₃ is more preferably 0.05 to 0.25%. SO₃ is usually introduced into the glass composition by adding a sulfate as a component of the glass material serving as a refining agent.

(Iron Oxide)

Iron oxide is present in the form of Fe₂O₃ or FeO in the glass composition. Fe₂O₃ has an ultraviolet absorbing ability, while FeO has a near-infrared absorbing ability. T-Fe₂O₃, which is total iron oxide in terms of Fe₂O₃, is adjusted within a range of 0.6 to 1.2%. If the content of T-Fe₂O₃ is too high, radiant heat of flames for melting the glass material is significantly absorbed by the upper surface of molten glass and cannot reach the bottom of a melting furnace to heat the glass material sufficiently. In terms of mass production, the content of T-Fe₂O₃ is preferably 1.1% or less, particularly preferably 1% or less. In order to obtain required optical properties, the content of T-Fe₂O₃ may be 0.7% or more, or even 0.8% or more.

Preferably, the mass ratio of FeO to T-Fe₂O₃ (i.e., a FeO ratio) is adjusted to 30% or less. If the FeO ratio is too high, silica-rich streaks and silica scum are likely to be formed in the molten glass material. On the other hand, a high FeO ratio is advantageous in enhancing the near-infrared absorbing ability. The FeO ratio is preferably 23% or more, more preferably 25% or more, and particularly preferably 26% or more, and it is preferably 27% or more in some cases.

(Other Minor Components)

The glass composition of the present invention may further contain other minor components in addition to the components listed above. Examples of the minor components include NiO, Cr₂O₃, Mo₂O₃, ZnO, SnO₂, and La₂O₃. The total content of the minor components is preferably 5% or less, more preferably 2% or less, and particularly preferably 1% or less. Preferably, the upper limits of the contents of these minor components are: 0.01% for NiO, Cr₂O₃, and Mo₂O₃; 0.1% for ZnO; and 1% for SnO₂ and La₂O₃. Preferably, the glass composition of the present invention is substantially free of components other than the components listed above and the minor components mentioned above. The glass composition of the present invention may be substantially free of components other than the components listed above (i.e., the components from SiO₂ to iron oxide described above one by one). The glass composition of the present invention is free of MnO.

In the present description, the contents of oxides of metals that can exhibit two or more valences in the glass composition, except for iron oxide, are calculated assuming that each of the metals in the form of an oxide has the valence described in the present description.

[Optical Properties]

In the present description, an ultraviolet transmittance (Tuv) measured according to ISO 9050: 1990 is used, and a visible light transmittance (YA) measured according to JIS R3106:1998, except for CIE Illuminant A, is used. One embodiment of the present invention provides a glass composition having, for a thickness of 3.5 mm, a low Tuv or 18% or less, a low T1500 of 34% or less, and a high YA of 72% or more. Needless to say, the thickness of “3.5 mm” is merely an example of the thickness and is not intended to mean that the glass composition of the present invention is always formed into a sheet shape with this thickness. It should be noted that the glass composition of the present invention is usually formed into a sheet shape with a predetermined thickness by a mass production method such as a float process and then annealed so as to obtain a glass product.

In some cases, a functional thin film, for example, a conductive film, a water-repellent film, a photocatalytic film, an infrared blocking film, or an ultraviolet blocking film, is formed on the surface of the glass sheet formed from the glass composition. Such a functional thin film is designed to minimize absorption of visible light. However, it is desirable that the YA of the glass composition itself be higher because the YA slightly decreases when the functional thin film is formed. To ensure sound insulation for vehicles, a window glass designed to be thick enough or a laminated glass including a pair of glass sheets and a resin interlayer film sandwiched therebetween is used in some cases. Also in these cases, it is desirable that the YA of the glass composition be higher because the YA decreases as the thickness increases. It is inevitable that the YA slightly deviates from the design value during mass production. In view of the above, when calculated assuming that the glass has a thickness of 3.5 mm, which is the typical thickness of glass for front door windows, the YA of the glass composition is preferably 71% or more, particularly preferably 71.5% or more, although the regulatory YA value is at least 70%. The YA of the glass composition tends to decrease when the glass composition is thermally tempered and irradiated with ultraviolet light, as described later. Therefore, it is desirable that the YA of the glass composition be equal to or higher than this regulatory value even after its anticipated decrease. The YA of the glass composition is preferably 72% or more, more preferably 72.5% or more, and particularly preferably 73% or more.

T1500 is a measure of a near-infrared transmittance. Like YA, T1500 also tends to decrease by thermal tempering and ultraviolet irradiation. The T1500 of the glass composition may be 34% or less. It is preferably 33.5% or less, and more preferably 33% or less. In order to effectively reduce the feeling of heat caused by near-infrared light passing through windows, the T1500 value is preferably 32.5% or less, particularly preferably 30% or less, and it is, for example, 29.5% or less.

Like YA and T1500, Tuv also tends to decrease by thermal tempering and ultraviolet irradiation. The Tuv of the glass composition may be 18% or less. It is preferably 17% or less, and more preferably 16% or less. In order to effectively reduce the effect of ultraviolet light passing through windows on human skin, the Tuv value is preferably 15% or less, and particularly preferably 14% or less.

[Thermal Tempering]

Thermal tempering (thermal strengthening) is a known technique for increasing the strength of a glass sheet by heating the glass sheet and then blowing a gas onto the surface of the heated glass sheet to quench the surface and form a compressive stress layer thereon. The temperature to which the glass sheet is heated is typically a temperature equal to or higher than the strain point of the glass composition of the glass sheet and equal to or lower than the softening point thereof. Another aspect of the present invention provides a strengthened glass sheet obtained by thermally tempering a glass sheet having the glass composition of the present invention. In general, but not always, the YA, T1500, and Tuv of the glass sheet having the glass composition of the present invention tend to decrease by thermal tempering. One embodiment of the present invention provides a strengthened glass sheet having a Tuv of 16% or less, preferably 14% or less, a YA of 71.5% or more, preferably 72% or more, more preferably 72.5% or more, and a T1500 of 32.5% or less, preferably 32% or less.

It is confirmed that there is no substantial change in the FeO ratio of the glass composition before and after thermal tempering. It is therefore presumed that the thermal tempering-induced changes in the optical properties of the glass composition do not depend on a change in the FeO ratio but on a shift of the absorption peak of FeO caused by fixation of the internal structure of the high-temperature glass composition by thermal tempering.

The magnitude of the compressive stress on the surface of the strengthened glass sheet is, for example, 80 to 140 MPa, particularly preferably 90 to 110 MPa, but is not particularly limited thereto.

[Ultraviolet Irradiation]

The YA, T1500, and Tuv of the glass sheet having the glass composition of the present invention tend to decrease by ultraviolet irradiation. One embodiment of the present invention provides a strengthened glass sheet obtained by irradiating the thermally tempered glass sheet with ultraviolet light. This ultraviolet-irradiated strengthened glass sheet has, for thickness of 3.5 mm, a Tuv of 15% or less, preferably 14% or less, more preferably 13.5% or less, a YA of 71% or more, preferably 71.5% or more, more preferably 72% or more, and a T1500 of 29.5% or less, preferably 29% or less, more preferably 28% or less.

The main cause of the changes in the optical properties by ultraviolet irradiation seems to be a change in the FeO ratio, specifically an increase in the FeO ratio, although the details are not yet clear. Presumably, when trivalent iron (Fe) is reduced to divalent iron (Fe), oxidation of, for example, trivalent cerium (Ce) to tetravalent cerium (Ce) occurs as a change in the valence of cerium. Divalent Fe generated subsequent to treatments such as ultraviolet irradiation has an absorption peak at a longer wavelength than that of divalent Fe originally present in the glass composition formed from the molten glass material. Probably, this is attributed to the difference in the arrangement of anions around divalent Fe ions. Specifically this is probably attributed to the fact that anions suitable not for divalent Fe ions but for trivalent Fe ions are coordinated to the reduced divalent Fe ions.

Ultraviolet irradiation may be carried out using an artificial light source such as an ultraviolet lamp or by sunlight. For example, the strengthened glass sheet may be irradiated with ultraviolet light on an ultraviolet irradiation line provided downstream of a thermal tempering line in a factory, or during storage after thermal tempering. It should be considered that the changes in the optical properties by ultraviolet irradiation also proceed during use of the glass sheet as a window glass. When the glass sheet is assumed to be used under the ultraviolet irradiation conditions, the ultraviolet irradiation of the glass sheet before the use as a window glass can be omitted.

It is preferable to carry out the ultraviolet irradiation so as to reduce T1500 by at least 1.0%, preferably at least 1.5%, and more preferably at least 2%, from that before the irradiation.

Hereinafter, the present invention will be described in more detail with reference to examples, but the following examples as well as the above description are merely illustrative examples of a preferred embodiment of the present invention.

Silica sand, dolomite, limestone, soda ash, salt cake, potassium carbonate, carbon, iron oxide, titanium oxide, and cerium oxide were blended so as to have the glass compositions shown in Table 1, and thus glass material batches were obtained. Each of these batches was melted in an electric furnace at 1450° C. The batch was kept molten for 4 hours, and then the resulting molten glass was cast on a stainless steel plate to obtain a glass sheet. The glass sheet was placed for 30 minutes in an annealing furnace maintained at 650° C., and then the annealing furnace was turned off to anneal the glass sheet to room temperature in the furnace. This annealing was performed at a cooling rate of about 0.1° C./sec. in a temperature range of 650 to 550° C. The resulting annealed glass sheet was polished to a thickness of 3.5 mm.

Next, each annealed glass sheet was subjected to thermal tempering. The thermal tempering was carried out in the following manner. The glass sheet was placed for 180 seconds in an electric furnace set at 700° C., and then the glass sheet was taken out from the electric furnace and quenched by blowing room-temperature air onto the glass sheet. This quenching was performed at a cooling rate of 80 to 100° C./sec. in a temperature range of 650 to 550° C. The resulting strengthened glass sheet had a surface compressive stress ranging from 90 to 110 MPa.

Subsequently, each strengthened glass sheet was irradiated with ultraviolet light. An ultraviolet irradiation apparatus “HLG-1S” manufactured by Suga Test Instruments Co., Ltd. was used for the ultraviolet irradiation. Specifically, the ultraviolet irradiation was carried out under the following conditions. A water-cooled xenon lamp built in the ultraviolet irradiation apparatus was used as a light source. A quartz and a #295 filter (i.e., a filter for blocking ultraviolet radiation below 295 nm) were used for filtering light. The discharge power was 5.4 kW. When the surface of the strengthened glass sheet was irradiated with ultraviolet light with wavelengths ranging from 300 to 400 nm, the illuminance of the surface was 180 W/m². The ultraviolet irradiation was carried out for 100 hours. Thus, an ultraviolet-irradiated glass sheet was obtained by irradiating each strengthened glass sheet with ultraviolet light.

Table 1 also shows the physical properties of the glass sheets thus obtained (including annealed glass sheets, strengthened glass sheets, and ultraviolet-irradiated glass sheets). In Table 1, in some examples, the total content of components is not 100%. This is because the number of significant digits and the degree of rounding vary from component to component.

Under these conditions, the annealed glass sheets of Examples 1 to 10 achieve both a YA of 72% or more and a T1500 of 34% or less and a Tuv of 16% or less as well as a low FeO ratio of 30 or less. The glass sheets of Examples 1 to 6, 9, and 10 achieve a Tuv of 15% or less.

A comparison among Comparative Example 2 (MgO: 3.2%, T1500: 34.2%), Example 2 (MgO: 2.1%, T1500: 33.5%), and Example 4 (MgO: 1.1%, T1500: 31.1%) shows that a decrease in the content of MgO to 2% or less leads to a significant decrease in the T1500. It is preferable to adjust the contents of the RO components so that the glass composition contains 1 to 2% MgO and 7 to 9.5% CaO and is substantially free of SrO and BaO. The glass sheets of Examples 1, 4, and 9 that meet these requirements achieve both a YA of 72.6% or more and a T1500 of 31.5% or less.

The glass sheets of Examples 4 to 10 having a total content of SiO₂ and Al₂O₃ of 73.9% or more achieve both a YA of 72.7% or more and a T1500 of 33% or less. Furthermore, the glass sheets of Examples 4, 6 to 8, and 10 having a total content of SiO₂ and Al₂O₃ of 74.3% or more achieve both a YA of 73% or more and a T1500 of 33% or less.

The Tuv, YA, and T1500 values are reduced by thermal tempering and ultraviolet irradiation, with a few exceptions (changes in the YA values by thermal tempering in Examples 2 and 5 and Reference Example). The strengthened glass sheets and the ultraviolet-irradiated glass sheets obtained in Examples achieve both high YA values and low T1500 values. For example, the ultraviolet-irradiated glass sheets obtained in Examples have both a YA of 71% or more and a T1500 of 29.5% or less and further have a Tuv of 15% or less.

Table 1 shows that, without having to produce glass compositions under strongly reducing conditions with a high FeO ratio of 30% or more, post-production treatments applied to the glass compositions to reduce their transmittances can provide glass sheets having excellent optical properties.

TABLE 1

| | | | | | | | Ref. | | | |
|---|---|---|---|---|---|---|---|---|---|---|
| | | Comparative Examples | | | | | Ex. | Examples | | |
| | | 1 | 2 | 3 | 4 | 5 | 1 | 1 | 2 | 3 |
| SiO₂ | | 70.6 | 70.6 | 70.6 | 70.6 | 70.6 | 71.7 | 71.8 | 71.7 | 71.6 |
| Al₂O₃ | | 1.5 | 1.6 | 1.6 | 1.6 | 1.6 | 1.6 | 1.8 | 1.6 | 1.6 |
| MgO | | 3.0 | 3.2 | 3.2 | 3.2 | 3.2 | 1.1 | 1.1 | 2.1 | 2.1 |
| CaO | | 8.2 | 8.0 | 8.0 | 8.0 | 8.0 | 8.0 | 8.9 | 8.0 | 8.0 |
| Na₂O | | 14.0 | 14.1 | 14.1 | 14.1 | 14.1 | 14.0 | 13.9 | 14.0 | 14.0 |
| K₂O | | 0.9 | 1.0 | 1.0 | 1.0 | 1.0 | 2.0 | 1.0 | 1.0 | 0.9 |
| TiO₂ | | 0.46 | 0.05 | 0.10 | 0.11 | 0.11 | 0.10 | 0.05 | 0.10 | 0.20 |
| CeO₂ | | 0.39 | 0.55 | 0.50 | 0.00 | 0.00 | 0.55 | 0.49 | 0.55 | 0.55 |
| SO₃ | | 0.16 | 0.15 | 0.14 | 0.13 | 0.12 | 0.12 | 0.22 | 0.16 | 0.17 |
| Fe₂O₃ | | 0.87 | 0.89 | 0.89 | 0.89 | 0.89 | 0.89 | 0.90 | 0.89 | 0.89 |
| FeO ratio | | 25.2 | 27.4 | 28.0 | 30.5 | 36.5 | 31.3 | 27.6 | 27.4 | 26.7 |
| RO | | 11.2 | 11.2 | 11.2 | 11.2 | 11.2 | 9.1 | 10.1 | 10.1 | 10.1 |
| SiO₂ + Al₂O₃ | | 72.1 | 72.2 | 72.2 | 72.2 | 72.2 | 73.3 | 73.6 | 73.3 | 73.2 |
| SiO₂/RO | | 6.3 | 6.3 | 6.3 | 6.3 | 6.3 | 7.9 | 7.1 | 7.1 | 7.1 |
| Annealed | YA | 72.4 | 71.3 | 70.9 | 68.1 | 65.1 | 71.9 | 72.6 | 72.5 | 72.4 |
| | T1500 | 36.0 | 34.2 | 33.4 | 27.8 | 22.1 | 26.9 | 31.5 | 33.5 | 34.0 |
| | Tuv | 11.3 | 12.8 | 12.8 | 16.2 | 16.6 | 15.0 | 14.0 | 13.9 | 13.2 |
| Strengthened | YA | 72.0 | 71.0 | 70.5 | 67.7 | 65.2 | 72.0 | 71.9 | 72.7 | 72.4 |
| | T1500 | 35.5 | 32.2 | 31.3 | 25.4 | 20.4 | 26.6 | 29.5 | 32.1 | 32.2 |
| | Tuv | 9.9 | 10.4 | 10.1 | 12.9 | 13.7 | 12.7 | 11.3 | 11.5 | 10.8 |
| UV | YA | 71.3 | 70.8 | 70.3 | 67.5 | 64.8 | 71.5 | 71.4 | 71.9 | 71.4 |
| | T1500 | 33.4 | 29.8 | 29.1 | 26.1 | 21.0 | 24.5 | 27.4 | 29.3 | 29.4 |
| | Tuv | 9.3 | 10.0 | 9.7 | 12.8 | 13.2 | 12.1 | 10.8 | 10.9 | 10.1 |
| | | Examples | | | | | | | | |
| | | 4 | 5 | 6 | 7 | 8 | 9 | 10 | 11 | 12 |
| SiO₂ | | 72.7 | 72.5 | 73.5 | 75.9 | 74.5 | 72.3 | 74.4 | 74.4 | 74.4 |
| Al₂O₃ | | 1.6 | 1.5 | 1.6 | 1.6 | 1.6 | 1.6 | 1.6 | 1.6 | 1.6 |
| MgO | | 1.1 | 2.1 | 2.1 | 2.0 | 2.1 | 1.1 | 2.0 | 2.0 | 2.0 |
| CaO | | 8.0 | 7.0 | 6.0 | 4.0 | 4.0 | 8.0 | 4.0 | 4.0 | 4.0 |
| Na₂O | | 14.0 | 14.0 | 14.0 | 14.0 | 15.0 | 14.1 | 14.8 | 14.8 | 14.8 |
| K₂O | | 0.9 | 0.9 | 1.0 | 0.8 | 0.9 | 1.0 | 0.9 | 0.9 | 0.9 |
| TiO₂ | | 0.10 | 0.20 | 0.20 | 0.19 | 0.20 | 0.30 | 0.46 | 0.11 | 0.11 |
| CeO₂ | | 0.55 | 0.65 | 0.65 | 0.55 | 0.65 | 0.65 | 0.87 | 0.00 | 0.00 |
| SO₃ | | 0.18 | 0.20 | 0.22 | 0.14 | 0.20 | 0.18 | 0.15 | 0.12 | 0.11 |
| Fe₂O₃ | | 0.89 | 0.89 | 0.89 | 0.91 | 0.89 | 0.89 | 0.91 | 0.89 | 0.89 |
| FeO ratio | | 27.5 | 26.9 | 27.5 | 25.3 | 27.5 | 28.2 | 25.5 | 32.3 | 35.6 |
| RO | | 9.1 | 9.1 | 8.1 | 6.1 | 6.1 | 9.1 | 6.1 | 5.9 | 5.9 |
| SiO₂ + Al₂O₃ | | 74.2 | 74.0 | 75.1 | 77.5 | 76.0 | 73.8 | 76.0 | 76.0 | 76.0 |
| SiO₂/RO | | 8.0 | 8.0 | 9.1 | 12.4 | 12.2 | 8.0 | 12.2 | 12.6 | 12.6 |
| Annealed | YA | 73.5 | 72.7 | 73.0 | 75.2 | 74.3 | 72.7 | 74.3 | 71.8 | 70.4 |
| | T1500 | 31.1 | 32.7 | 31.5 | 32.9 | 30.0 | 29.9 | 32.7 | 20.8 | 17.9 |
| | Tuv | 14.9 | 12.9 | 13.5 | 15.2 | 15.5 | 12.7 | 11.1 | 25.3 | 26.0 |
| Strengthened | YA | 73.2 | 72.8 | 72.9 | 75.0 | 74.1 | 72.1 | 74.0 | 72.2 | 70.3 |
| | T1500 | 30.2 | 31.9 | 30.4 | 32.1 | 29.2 | 28.4 | 31.7 | 21.3 | 17.2 |
| | Tuv | 12.5 | 10.7 | 11.2 | 12.8 | 13.1 | 10.3 | 9.2 | 22.0 | 22.8 |
| UV | YA | 72.6 | 71.6 | 71.7 | 73.5 | 72.8 | 71.1 | 72.6 | 71.0 | 69.3 |
| | T1500 | 27.6 | 28.4 | 27.4 | 28.4 | 26.0 | 25.8 | 27.3 | 21.2 | 17.8 |
| | Tuv | 11.9 | 10.2 | 10.8 | 12.6 | 12.8 | 9.9 | 9.0 | 21.4 | 22.3 |

*Annealed: Annealed glass sheets
Strengthened: Thermally tempered glass sheets
UV: Glass sheets obtained by irradiating thermally tempered glass sheets with ultraviolet light
*YA: Visible light transmittance
T1500: Light transmittance at a wavelength of 1500 nm
Tuv: Ultraviolet transmittance

### INDUSTRIAL APPLICABILITY

The glass composition of the present invention is suitable for use in applications required to absorb ultraviolet and near-infrared light but to allow visible light to pass through, for example, in vehicle and building windows. The glass composition of the present invention has properties suitable for use not only in windows but also, for example, in building top lights and facades. The glass composition of the present invention can be used specifically as a thermally tempered strengthened glass sheet or a unstrengthened annealed glass sheet.

1. A glass composition comprising, in mass %:
71 to 78% SiO₂;
0 to 5% B₂O₃;
1 to 5% Al₂O₃;
1 to 3.5% MgO;
2 to 9.5% CaO;
0 to 1% SrO;
0 to 1% BaO;
0 to 3% Li₂O;
10 to 18% Na₂O;
0 to 3% K₂O;
0 to 1% TiO₂;
0 to 1% CeO₂;
0 to 0.5% SO₃; and
0.6 to 1.2% T-Fe₂O₃, which is total iron oxide in terms of Fe₂O₃, wherein
the glass composition is free of MnO,
a total content of TiO₂ and CeO₂ is 0.05% or more,
a total content of Li₂O, Na₂O, and K₂O is 12 to 18%, and
a total content of MgO, CaO, SrO, and BaO is 10.5% or less.

2. The glass composition according to claim 1, wherein a total content of SiO₂ and Al₂O₃ is 73.9% or more.

3. The glass composition according to claim 2, wherein the total content of SiO₂ and Al₂O₃ is 74.3% or more.

4. The glass composition according to claim 3, wherein a content of SiO₂ is 74% or more.

5. The glass composition according to claim 4, wherein the content of SiO₂ is 75% or more.

6. The glass composition according to claim 2, wherein
a content of MgO is 2 to 3.5%,
a content of CaO is 4 to 7%, and
the glass composition is substantially free of SrO and BaO.

7. The glass composition according to claim 1, wherein
a content of MgO is 1 to 2%,
a content of CaO is 7 to 9.5%, and
the glass composition is substantially free of SrO and BaO.

8. The glass composition according to claim 1, wherein a FeO ratio represented by a mass ratio of FeO to T-Fe₂O₃ is 23% or more.

9. The glass composition according to claim 1, wherein a content of TiO₂ is 0.05% or more.

10. The glass composition according to claim 1, wherein a content of CeO₂ is 0.05% or more.

11. The glass composition according to claim 10, wherein a FeO ratio represented by a mass ratio of FeO to T-Fe₂O₃ is 30% or less.

12. The glass composition according to claim 1, having, for a thickness of 3.5 mm, an ultraviolet transmittance of 18% or less, a visible light transmittance of 72% or more, and a light transmittance of 34% or less at a wavelength of 1500 nm.

13. A strengthened glass sheet obtained by thermally tempering a glass sheet comprising the glass composition according to claim 1.

14. The strengthened glass sheet according to claim 13, wherein the strengthened glass sheet has, for a thickness of 3.5 mm, an ultraviolet transmittance of 16% or less, a visible light transmittance of 71.5% or more, and a light transmittance of 32.5% or less at a wavelength of 1500 nm.

15. A strengthened glass sheet obtained by irradiating the strengthened glass sheet according to claim 13 with ultraviolet light, the ultraviolet-irradiated strengthened glass sheet having, for a thickness of 3.5 mm, an ultraviolet transmittance of 15% or less, a visible light transmittance of 71% or more, and a light transmittance of 29.5% or less at a wavelength of 1500 nm.
